(19) United States
(12) Patent Application Publication
(10) Pub. No.: US 2013/0006526 A1
(43) Pub. Date: Jan. 3, 2013

(54) GPS VEHICLE DOCKING STATION FOR HANDHELD DEVICES

(76) Inventor: Christopher T. Banus, Nashua, NH (US)

(21) Appl. No.: 13/537,134

(22) Filed: Jun. 29, 2012

Related U.S. Application Data
(60) Provisional application No. 61/502,351, filed on Jun. 29, 2011.

(51) Int. Cl. G01C 21/34

(52) U.S. Cl. 701/444

(57) ABSTRACT

A GPS docking station for a multi-purpose handheld device mounted to the interior of a vehicle and provides easily viewable and readable GPS display under control of the handheld device. The docking station can further include a keypad and/or audio inputs/outputs. Communication with the handheld device can be through a connector, a cable, and/or wirelessly, e.g. using Bluetooth. The GPS display can be a touch screen. A handheld device cradle can physically support the handheld device, and can be cooperative with the GPS display or separately mountable within the vehicle. In embodiments, the handheld device can perform non-GPS functions using its built-in keypad and display, while simultaneously displaying GPS information on the docking station display and broadcasting GPS announcements through the audio outputs of the docking station. At least one keypad key can be dedicated to a special GPS-relevant function, and can include a visible indication of its function.

### RELATED APPLICATIONS

This application claims the benefit of U.S. Provisional Application No. 61/502,351, filed Jun. 29, 2011 which is herein incorporated by reference in its entirety for all purposes.

### FIELD OF THE INVENTION

The invention relates to docking stations for computing devices, and more particularly to docking stations for use in vehicles.

### BACKGROUND OF THE INVENTION

Handheld electronic devices are being used for an increasing number of applications, including personal organization (for example as a personal digital assistant, or “PDA”), navigation (for example as a global positioning system, or “GPS”), internet access (for example as a device with WI-FI and/or “3G” wireless cell phone technology), reading printed literature (for example as an e-reader), and communications (for example as a cellular telephone). Typically, a single handheld device is able to perform many or all of these functions, and many more.

In particular, it can be very convenient to include GPS capability in a multi-purpose handheld device, since the device is almost always available, and can be used for navigation any time it is needed, including when an unexpected need arises. Also, the same device can be used when the user is walking, when the user is riding a bicycle, when the user is traveling in his or her automobile, and when the user is traveling in someone else's vehicle, thereby saving cost and eliminating the need to purchase and maintain multiple GPS devices.

As with most modern digital devices, typical GPS units allow for extensive personalization, such as setting audio and display preferences, creating and maintaining a list of points of interest, and maintaining a list of frequent and/or “favorite” destinations. A further advantage of including GPS capability in a multi-purpose handheld device is the elimination of any need to separately configure and personalize the settings and information for a plurality of special purpose GPS devices, each of which is dedicated for use under specific circumstances.

For example, if a husband has occasion to drive his wife's car, he might face the choice of either using his wife's automotive GPS, which is set to her preferences, or detaching his own automotive GPS from his car and temporarily installing it in his wife's car. However, if the husband carries a smart phone which he uses for GPS navigation, he can simply pull out his smart phone and start driving. This approach can be made even easier by using a mounting cradle to support the handheld device in the vehicle, while the user maintains both hands free for driving. If both the husband and the wife carry smart phones with GPS capability, and if mounting cradles are provided in both of their cars, then dedicated automotive GPS units are not needed, since each driver can simply use his or her smart phone for navigation in either vehicle.

However, there are several major drawbacks to using a multi-purpose handheld device for GPS navigation while driving a vehicle. First, the display on a handheld device is typically quite small. While it may be large enough for viewing when the device is held in a user's hand and the display is positioned near to the user's eyes, it can be difficult to see details on the display when the device is mounted in a cradle which is attached to the windshield or to the dashboard of a vehicle, thereby locating the display much further from the user's eyes.

Second, the keypad on a handheld device is typically quite small, and hard to view and operate from a distance when the device is mounted in a cradle within a vehicle. While use of a GPS is mostly passive, input is needed when selecting a destination, answering a question (e.g. “do you want to avoid tolls?”) and changing a setting (e.g. adding a favorite destination, changing the time zone, changing the destination, or (for some devices) changing from day mode to night mode).

Third, because the device is multi-purpose, it may be needed for some other purpose while the GPS function is in use. For example, if a phone call is received, the display may switch away from GPS mode, and/or the GPS synthesized voice may temporarily suspend the ongoing telephone call each time a navigation direction is given. In general, it is not desirable to lose use of the other available functions of a multi-purpose device during the entire duration of a GPS-guided trip in a vehicle.

What is needed, therefore, is an apparatus which can allow a multi-purpose handheld device to be used conveniently in a vehicle as a GPS device, while providing easily viewable and accessible display and keypad functions for GPS control, and while simultaneously providing access to other functions of the multi-purpose handheld device.

### SUMMARY OF THE INVENTION

A GPS docking station for a multi-purpose handheld device is temporarily and/or permanently mountable within the interior of a vehicle. The docking stations provides enlarged and easily viewable and readable GPS display under control of the handheld device, thereby allowing the driver to conveniently view the GPS graphical indications as needed. In embodiments, the docking station further includes a keypad and/or audio outputs which are accessible to the handheld device. In some of these embodiments, the keypad is a physical keypad, while in other embodiments the keypad is a virtual keypad which is presented on a touch-sensitive region of the display.

In certain embodiments, at least one key of the docking station keypad is dedicated to a special GPS-relevant function. And in some of these embodiments, the dedicated key includes a visible indication of its GPS-relevant function. Embodiments also include audio outputs for broadcasting GPS announcements provided by the GPS at a volume which can be heard in a noisy automobile.

In some embodiments the GPS docking station is temporarily or permanently attachable to a dashboard, window, or other structure within the vehicle, while in other embodiments the GPS docking station can be permanently mounted within the dashboard of the vehicle.

In various embodiments, the docking station can communicate with the handheld device through a physical connector, a communication cable, and/or by wireless communication, such as Bluetooth. In some embodiments, the GPS display is a touch screen.

In certain embodiments, a mounting cradle is included which can physically support the handheld device, so that the driver has both hands free for operating the vehicle. The mounting cradle can be cooperative with the GPS display, or separately mountable to the windshield, dashboard, side window, or other structure within the vehicle. The docking station can include a connector or cable for communication with the handheld device and/or for charging batteries of the handheld device.

In various embodiments, when linked with the docking station, the handheld device is able to perform other, non-GPS functions using its built-in keypad and display, while simultaneously continuing to display GPS functionality on the docking station display and broadcasting GPS announcements through the audio outputs of the docking station.

The present invention is a GPS vehicle docking station for a handheld device. The docking station includes a GPS display mounted to a structure within the interior of the vehicle and configured to be visible to and readable by an operator of the vehicle, and a communication mechanism enabling communication between the GPS display and a handheld device, the GPS display being able to display GPS information provided by the handheld device.

In embodiments, the GPS display is attached to at least one of a windshield and a dashboard of the vehicle. In some embodiments, the GPS display is mounted within a dashboard panel of the vehicle.

Certain embodiments further include an audio output device, the audio output device being able to broadcast GPS announcements provided by the handheld device.

Some embodiments further include an audio input device, the audio input device being able to receive voice commands from the vehicle operator for processing by the handheld device.

Various embodiments further include a keypad, the keypad being able to receive commands for transmission to the handheld device. In some of these embodiments at least one key of the keypad is dedicated to a specific function relevant to GPS navigation. And in some of these embodiments the key includes a visible indication of the dedicated function. In other embodiments the keypad is a virtual keypad which is displayed on a touch-sensitive region of the GPS display.

In certain embodiments the communication mechanism is a cable having a connector which is compatible with a connector included in the handheld device. And in some of these embodiments the connector is a mini-USB connector.

In various embodiments the communication mechanism is wireless communication. In some of these embodiments the wireless communication is Bluetooth communication. In other of these embodiments the wireless communication is 802.11b communication.

Embodiments further include a handheld device mounting cradle. In some of these embodiments the mounting cradle is physically cooperative with the GPS display. In other of these embodiments the mounting cradle is physically independent of the GPS display, and is mountable to an internal structure of the vehicle. And in some of these embodiments the internal structure is one of a dashboard a windshield, and a window.

Other embodiments that include a handheld device mounting cradle further include an electrical connector cooperative with the mounting cradle, the electrical connector being configured to automatically connect the docking station with the handheld device when the handheld device is installed in the mounting cradle. Yet other of these embodiments further include an electrical connector or cable cooperative with the mounting cradle and configured to provide recharging power to the handheld device.

In various embodiments the handheld device is able to display GPS information on the GPS display while simultaneously displaying information unrelated to GPS navigation on a display which is incorporated in the handheld device.

In some embodiments the docking station further comprises a docking station audio output device, and the handheld device is able to broadcast GPS audio information on the docking station audio output device while simultaneously broadcasting audio information unrelated to GPS navigation using an audio output device which is incorporated in the handheld device.

And in other embodiments the GPS display is a touch-screen display.

The present invention is a GPS vehicle docking station for a handheld device. The docking station includes a GPS display mounted to a structure within the interior of the vehicle and configured to be visible to and readable by an operator of the vehicle, and a communication mechanism enabling communication between the GPS display and a handheld device, the GPS display being able to display GPS information provided by the handheld device.

In embodiments, the GPS display is attached to at least one of a windshield and a dashboard of the vehicle. In some embodiments the GPS display is mounted within a dashboard panel of the vehicle.

Various embodiments further include an audio output device, the audio output device being able to broadcast GPS announcements provided by the handheld device. Certain embodiments further include an audio input device, the audio input device being able to receive voice commands from the vehicle operator for processing by the handheld device.

Some embodiments further include a keypad that is able to receive commands for transmission to the handheld device. In some of these embodiments at least one key of the keypad is dedicated to a specific function relevant to GPS navigation. And in some of these embodiments the key includes a visible indication of the dedicated function. In other of these embodiments the keypad is a virtual keypad which is displayed on a touch-sensitive region of the GPS display.

In various embodiments the communication mechanism is a cable having a connector which is compatible with a connector included in the handheld device. In some of these embodiments the connector is a mini-USB connector.

In certain embodiments the communication mechanism is wireless communication. In some of these embodiments the wireless communication is Bluetooth communication. In other of these embodiments the wireless communication is 802.11b communication.

Some embodiments further include a handheld device mounting cradle. In some of these embodiments the mounting cradle is physically cooperative with the GPS display. In other of these embodiments the mounting cradle is physically independent of the GPS display, and is mountable to an internal structure of the vehicle. And in some of these embodiments the internal structure is one of a dashboard a windshield, and a window.

Other of these embodiments further include an electrical connector cooperative with the mounting cradle, the electrical connector being configured to automatically connect the docking station with the handheld device when the handheld device is installed in the mounting cradle. And still other of these embodiments further include an electrical connector or cable cooperative with the mounting cradle and configured to provide recharging power to the handheld device.

In various embodiments the handheld device is able to display GPS information on the GPS display while simultaneously displaying information unrelated to GPS navigation on a display which is incorporated in the handheld device.

In certain embodiments the docking station further comprises a docking station audio output device, and the handheld device is able to broadcast GPS audio information on the docking station audio output device while simultaneously broadcasting audio information unrelated to GPS navigation using an audio output device which is incorporated in the handheld device.

And in some embodiments the GPS display is a touch-screen display.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of an embodiment of the present invention installed in the dashboard of an automobile and showing a handheld device mounted in a cradle, GPS information from the handheld device being displayed on the enlarged display of the docking station while telephone-related information is displayed on the built-in display of the handheld device;

FIG. 2 is a close-up view of the dashboard region containing the GPS docking station of FIG. 1; and

FIG. 3 is a perspective view of an embodiment that is externally mounted to the dashboard of a vehicle.

### DETAILED DESCRIPTION

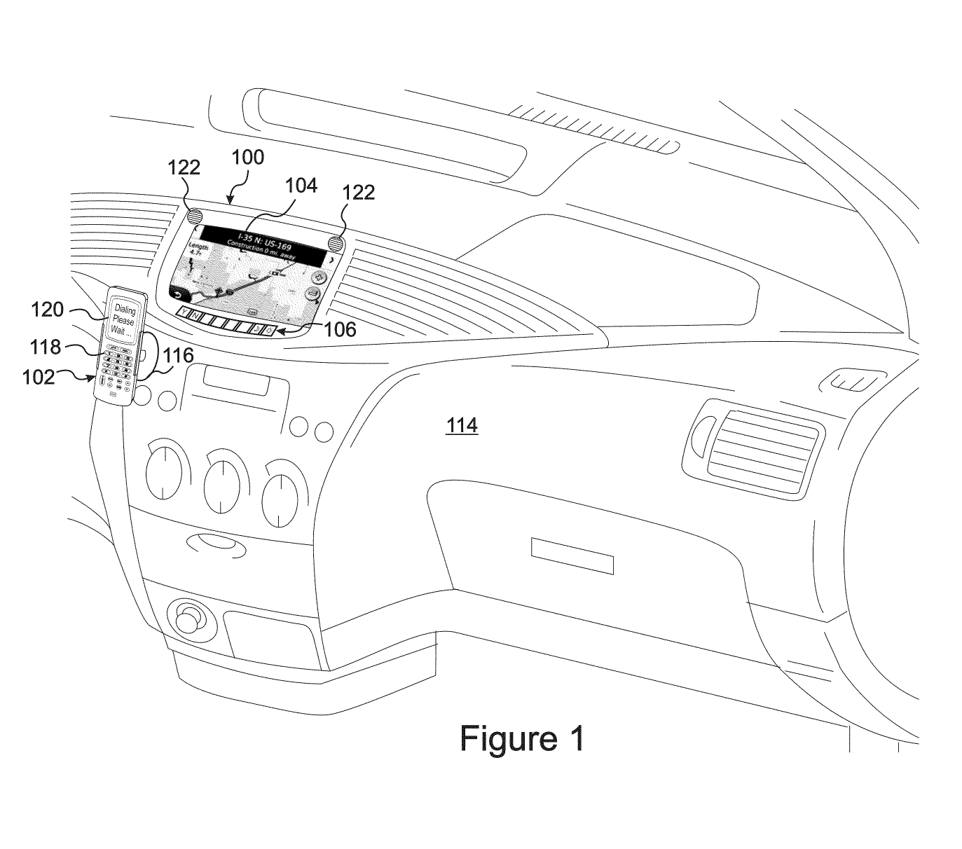

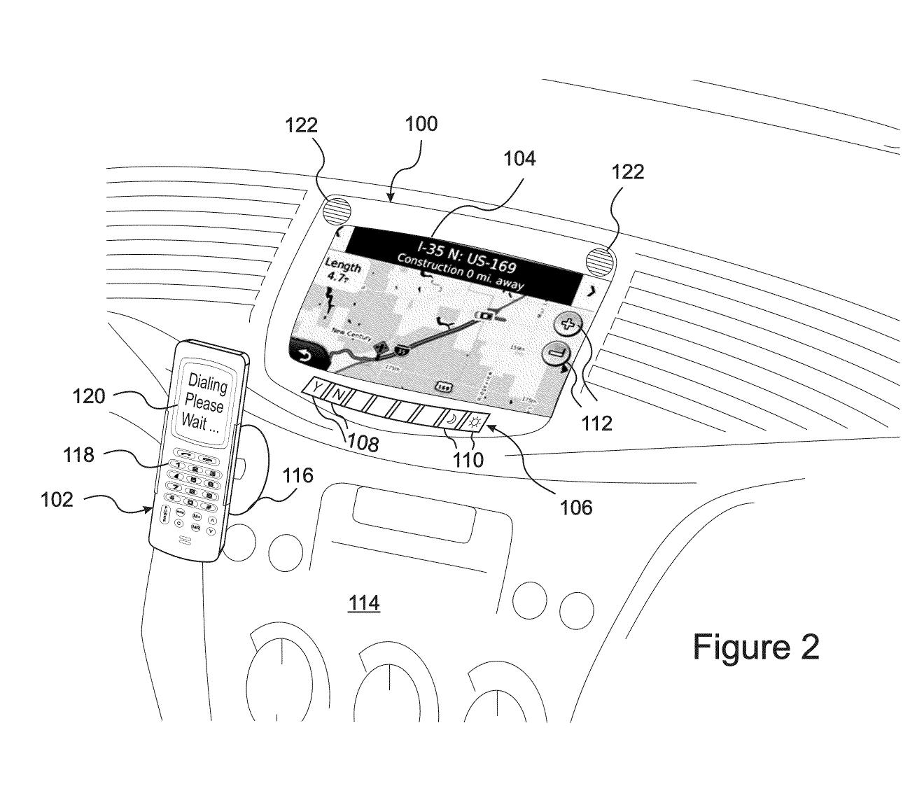

With reference to FIGS. 1 and 2, the present invention is a docking station 100 for a multi-purpose handheld device 102 which is mountable within the interior of a vehicle and is able to physically support the handheld device 102, so that the driver has both hands free for operating the vehicle. The docking station 100 provides enlarged and easily accessible GPS display 104 and keypad 106 functions under control of the handheld device 102, thereby allowing the driver to conveniently view and access the GPS functions as needed. Since the display 104 and keypad 106 are under control of the handheld device 102, their behavior and settings will reflect settings established on the handheld device 102. If the docking station 100 is used alternately with more than one handheld device 102, various personalized settings and preferences established on each handheld device 102 will automatically be reflected in the behavior of the display 104 and keyboard 106 according to which handheld device 102 is being used.

In various embodiments, the docking station 100 can communicate with the handheld device 102 through a physical connector or through a communication cable. In other embodiments, as is illustrated in FIGS. 1 and 2, the docking station 100 can communicate with the handheld device 102 by wireless communication, such as Bluetooth.

In some embodiments, at least one key 108, 110 of the docking station keypad 106 is dedicated to a special GPS-relevant function. In some of these embodiments, the dedicated key 108, 110 includes a visible indication of its GPS-relevant function. In the embodiment of FIGS. 1 and 2, a pair of keys 108 is dedicated to giving “yes” and “no” replies to the GPS, and a second pair of keys 110 is dedicated to changing the display mode between “day” and “night” mode. In addition, in the embodiment of FIGS. 1 and 2 special buttons 112 are provided for zooming the display image in and out.

As shown in FIGS. 1 and 2, embodiments also include audio outputs 122 for broadcasting the synthesized speech announcements and directions provided by the GPS at a volume which can be heard even in a noisy automobile. Some embodiments include audio inputs for receiving audible commands from the user for processing by the handheld device 102.

In the embodiment of FIGS. 1 and 2, the mounting cradle is of a size and design similar to typical mounting cradles known in the art for mounting cellular telephones and other handheld devices to automotive dashboards 104 and windows. In the embodiment of FIGS. 1 and 2, communication between the handheld device 102 and the docking station 100 is wireless, so no physical connection between the handheld device and the docking station is needed. In some embodiments, wired communication is provided, whereby a communication cable extends from the docking station and connects, for example, to a mini-USB port on the handheld device.

In the embodiment of FIGS. 1 and 2, the GPS display 104 is permanently mounted within the vehicle dashboard 114, and a separate mounting cradle 116 is attached to the dashboard, as shown in the figures, or to the front or side window. In similar embodiments, the GPS is temporarily and/or permanently attachable to the dashboard, to the windshield, and/or to some other structure within the vehicle.

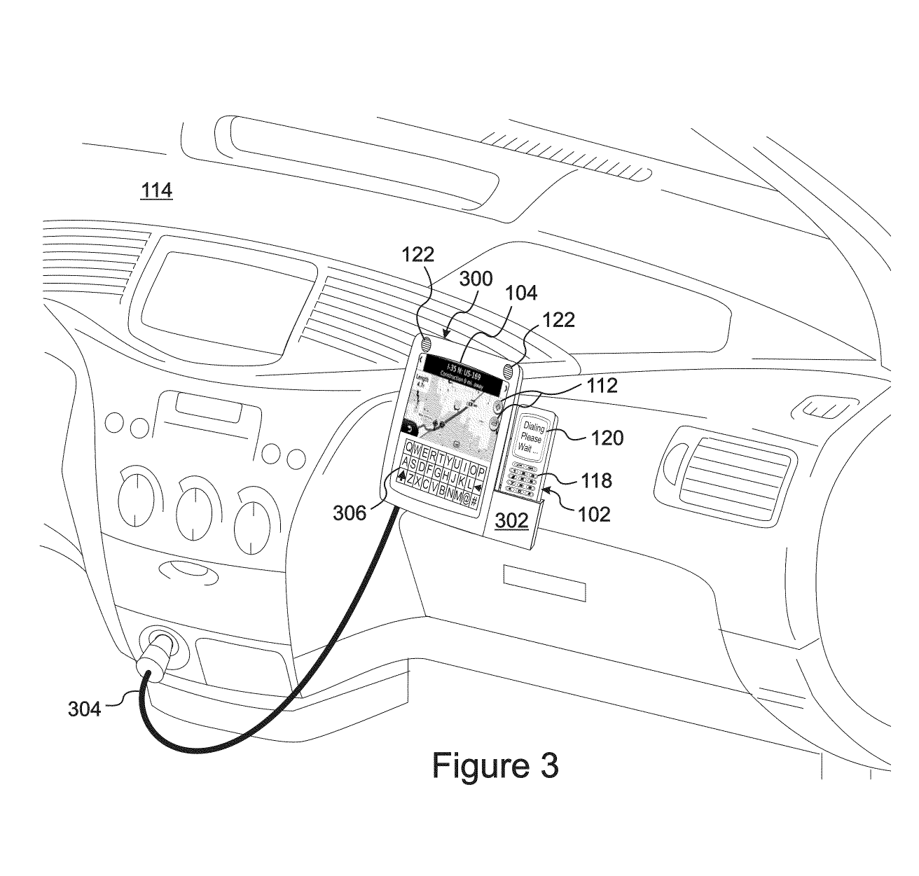

For example, in the embodiment 300 of FIG. 3 the display 300 is externally mounted to the dashboard 114, and the mounting cradle 302 is physically cooperative with the display 300. In the embodiment of FIG. 3, a physical connector is provided in the mounting cradle 302, which automatically forms a wired connection between the docking station 300 and the handheld device 102 when the handheld device is placed into the mounting cradle 302. In this embodiment, the display 300 is connected by a power cable 304 to the vehicle's electrical system, and the mounting cradle 302 provides recharging power to the handheld device 102.

In still other embodiments where the display 300 is in wireless communication with the handheld device 102, a mounting cradle is not included, and the user either carries the handheld device 102 in a holster or pocket, or purchases a separate, commercially available mounting cradle 116 to support the handheld device 102.

In the embodiment of FIG. 3, the screen 300 is a touch screen, and the keypad 306 is a virtual keypad displayed on the screen 300.

In the embodiments of FIGS. 1-3, when the handheld device 102 is linked with the docking station 100, the handheld device 102 is able to perform other, non-GPS functions using its built-in keypad 118, display 120, and audio output, while simultaneously continuing to display GPS functionality on the docking station display 104, 300, receive input from the docking station keypad 106, 306, and make GPS announcements using the docking station audio outputs 122.

In FIGS. 1-3 the handheld device 102 is shown to be functioning as a cellular telephone, using voice commands and/or the built-in keypad 118 and screen 120 which are included with the handheld device 102, while simultaneously displaying GPS information on the docking station display 104, 300 and broadcasting GPS announcements through the audio outputs 122 of the docking station 100, 300.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A GPS vehicle docking station for a handheld device, the docking station comprising:
a GPS display mounted to a structure within the interior of the vehicle and configured to be visible to and readable by an operator of the vehicle; and
a communication mechanism enabling communication between the GPS display and a handheld device, the GPS display being able to display GPS information provided by the handheld device.

2. The docking station of claim 1, wherein the GPS display is attached to at least one of a windshield and a dashboard of the vehicle.

3. The docking station of claim 1, wherein the GPS display is mounted within a dashboard panel of the vehicle.

4. The docking station of claim 1, further comprising an audio output device, the audio output device being able to broadcast GPS announcements provided by the handheld device.

5. The docking station of claim 1, further comprising an audio input device, the audio input device being able to receive voice commands from the vehicle operator for processing by the handheld device.

6. The docking station of claim 1, further comprising a keypad, the keypad being able to receive commands for transmission to the handheld device.

7. The docking station of claim 6, wherein at least one key of the keypad is dedicated to a specific function relevant to GPS navigation.

8. The docking station of claim 7, wherein the key includes a visible indication of the dedicated function.

9. The docking station of claim 6, wherein the keypad is a virtual keypad which is displayed on a touch-sensitive region of the GPS display.

10. The docking station of claim 1, wherein the communication mechanism is a cable having a connector which is compatible with a connector included in the handheld device.

11. The docking station of claim 10, wherein the connector is a mini-USB connector.

12. The docking station of claim 1, wherein the communication mechanism is wireless communication.

13. The docking station of claim 12, wherein the wireless communication is Bluetooth communication.

14. The docking station of claim 12, wherein the wireless communication is 802.11b communication.

15. The docking station of claim 1, further comprising a handheld device mounting cradle.

16. The docking station of claim 15, wherein the mounting cradle is physically cooperative with the GPS display.

17. The docking station of claim 15, wherein the mounting cradle is physically independent of the GPS display, and is mountable to an internal structure of the vehicle.

18. The docking station of claim 17, wherein the internal structure is one of a dashboard a windshield, and a window.

19. The docking station of claim 15, further comprising an electrical connector cooperative with the mounting cradle, the electrical connector being configured to automatically connect the docking station with the handheld device when the handheld device is installed in the mounting cradle.

20. The docking station of claim 15, further comprising an electrical connector or cable cooperative with the mounting cradle and configured to provide recharging power to the handheld device.

21. The docking station of claim 1, wherein the handheld device is able to display GPS information on the GPS display while simultaneously displaying information unrelated to GPS navigation on a display which is incorporated in the handheld device.

22. The docking station of claim 1, wherein the docking station further comprises a docking station audio output device, and the handheld device is able to broadcast GPS audio information on the docking station audio output device while simultaneously broadcasting audio information unrelated to GPS navigation using an audio output device which is incorporated in the handheld device.

23. The docking station of claim 1, wherein the GPS display is a touch-screen display.
